(19) United States
(12) Patent Application Publication
(10) Pub. No.: US 2015/0065090 A1
(43) Pub. Date: Mar. 5, 2015

(54) WEARABLE RING-SHAPED ELECTRONIC DEVICE AND THE CONTROLLING METHOD THEREOF

(71) Applicant: Hung-Yao Yeh, Taipei City (TW)

(72) Inventor: Hung-Yao Yeh, Taipei City (TW)

(21) Appl. No.: 14/471,868

(22) Filed: Aug. 28, 2014

(30) Foreign Application Priority Data
Aug. 30, 2013 (TW) 102131194

(51) Int. Cl. H04M 1/60; H04W 12/06; H04W 4/16; H04W 4/00

(52) U.S. Cl. CPC H04M 1/6041; H04W 4/008; H04W 12/06; H04W 4/16
USPC 455/411; 455/563

(57) ABSTRACT

The present invention discloses a wearable ring-shaped electronic device and the controlling method thereof, more specifically, the present invention is a novel model of an electronic device with a ring shape which is capable of being worn on the finger of a user. Furthermore, the present invention is capable of being controlled by voice, motion, orientations, buttons or a touch panel set on the surface thereof so as to provide a corresponding function.

### PRIORITY CLAIM

This application claims the benefit of the filing date of Taiwan Patent Application No. 102131194, filed Aug. 30, 2013, entitled “WEARABLE RING-SHAPED ELECTRONIC DEVICE AND THE CONTROLLING METHOD THEREOF,” and the contents of which are hereby incorporated by reference in their entirety.

### FIELD OF THE INVENTION

The present invention relates to a wearable ring-shaped electronic device, more particularly, to a wearable electronic device with a ring shape which can be controlled in many different ways.

### BACKGROUND

As a result of the monumental progress of smart-phone technology, the function of smart-phones are no longer constrained to just answering phone calls and sending messages, but also taking photos, acting as a personal digital assistant, playing media and allowing wireless communications. Aside from that, smart-phones have the normal functions of receiving and sending e-mail, surfing the Internet and being able to connect to Wi-Fi, 2G, 3G, 4G, and LTE.

Furthermore, users mainly control smart-phones by touching the screen. Take the iPhone for example, it comprises five button and the button used most often is the Home Button at the bottom of the screen. The Home Button is mainly used close Apps, wake up the phone and call out the task management. When the iPhone is in standby mode, pressing the button will turn on the phone. Along with the home button, the three buttons set on the side of the phone are used to control the volume or put the iPhone into mute mode.

Notably, the screen of the iPhone has many sensors. When the face of the user gets in proximity of the transducers while talking on the phone, the screen will be shut off temporarily to save energy and reduce the chance of misusing the phone by accidently touching the screen with the face or ear of the user. The linear visible light sensor can adjust the light of the screen depending on the lighting condition it is in to conserve energy. The triaxial movement sensor allows adjustment to either a longitudinal direction or a cross direction depending on the orientation of the phone. The accelerometer is mainly used in games, wherein the phone further comprises a gyroscope to enhance the sensing of movement from the user.

Aside from the sensors, the iPhone has a microphone and a loudspeaker set on the bottom of the iPhone. Another receiver is set on the top of the screen of the phone and is used to answer phone calls. The top of the phone also comprises a small microphone used to reduce noise in different conditions while talking. At the same time, there is a 3.5 micrometer TRS terminal, set on the side of the phone for connecting to sound exporting devices (such as earphones or headphones). For convenience, the iPhone further designs a multi-functional earphone which has the function of adjusting the volume, playing or stopping music and answering or hanging up the phone.

For communication uses, besides the iPhone, bluetooth sensors are built in most of smart-phones to support bluetooth device. The user adheres to the following steps to use the phone: user retrieves the phone with one hand from the area the phone was placed; then uses the thumb of the same hand or any finger from the other hand to press the open button; uses the same thumb or finger to unlock the screen in predetermined ways, such as inputting numbers or drawing a path; and then finally uses the same thumb or finger to click the screen and control the phone.

### SUMMARY OF THE INVENTION

When the applicant researched the behavior of users, the applicant found two problems with the prior art. The first problem is that when the user holds and operates the phone in one hand, the grip is often loose and subsequently causes accidental drop and damages on the phone. The other problem is that when the user is controlling the phone, the eyes of the user will have to focus on the screen which interrupts the user from other activities, such as driving, just to use the phone.

To solve the above mentioned problems, most users will use two hands to control the phone or rely on protection cover to prevent the phone from being dropped and damaged. At the same time, manufacturers have been developing bluetooth headsets which allow users to have hands-free conversation. This also reduces the frequency of dropping the phone as the phone is handled less often. Some manufacturers have even begun to propose smart-watches that grant many functions mentioned above through a controllable watch.

Because the bluetooth headset is fixed on the ear, the headset supplies limited functionality of answering or dialing phone calls as the user can not view or move the headset. An inconvenience with the smart-watch is that the user has to use both hands to control the smart-watch. The smart-watch is set up on the wrist of one hand and the user has to control it through a screenpanel or buttons using the other hand. And it is a bit awkward to use the smart-watch as an audio device fastened on the wrist. Therefore, figuring out a way to conveniently provide the benefits of phone and more without the above mentioned inconveniences is a worthy concern.

To solve the problems mentioned in prior art, the present invention proposes a wearable ring-shaped electronic device, which is usable with one hand to take advantage of the flexibility of one's finger, avoid phone drop, reduce the distraction from other activities when using the phone, and supply multiple functions to the user. More particularly, the present invention is fixed close to the knuckle of a finger when in use. The fixed place is in a relatively convenient area, so the user can control it without having to verify it's whereabouts before using it.

Furthermore, the wearable ring-shaped electronic device is worn close to one knuckle, allowing another finger of the same hand to control the device, unlike a smart-watch which needs two hands to control. Aside from that, the user can use one hand to control the wearable ring-shaped electronic device and perform assigned functions by inputting commands using the gesture or orientation sensors. The prevent invention can not only be controlled by movement but also through voice commands, buttons or touch-based gestures.

The assigned functions mentioned above comprises voice dialing, communicating, coupling, exchanging data, controlling remotely, game controlling or playing music with an outside device. The present invention also includes a function for conserving energy which senses whether the ring is worn or not through a sensing module. If the ring is not being worn, the ring can turn off some of the modules or adjust to a lower power consumption mode to conserve energy, which is the mode changing function of the present invention.

To summarize, the present invention discloses a wearable ring shaped electronic device, more specifically, the present invention is an electronic device having a ring shape which is capable of being worn on the finger of a user. Furthermore, the present invention is capable of receiving inputs in the forms of sound, motion, orientation, buttons or a touch panel entrenched on the surface thereof so as to provide corresponding functions directly or through an outside device.

Many other advantages and features of the present invention will be further understood by the following detailed description and the appended drawings.

### BRIEF DESCRIPTION OF THE DRAWINGS

Some of the embodiments will be described in detail, with reference to the following figures, wherein like designations denote like members, wherein:

FIG. 1 is a schematic diagram of the function block of the wearable electronic device in an embodiment of the invention.

FIG. 2A to FIG. 2C are schematic diagrams of the wearable electronic device of the present invention in use in an embodiment of the invention.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

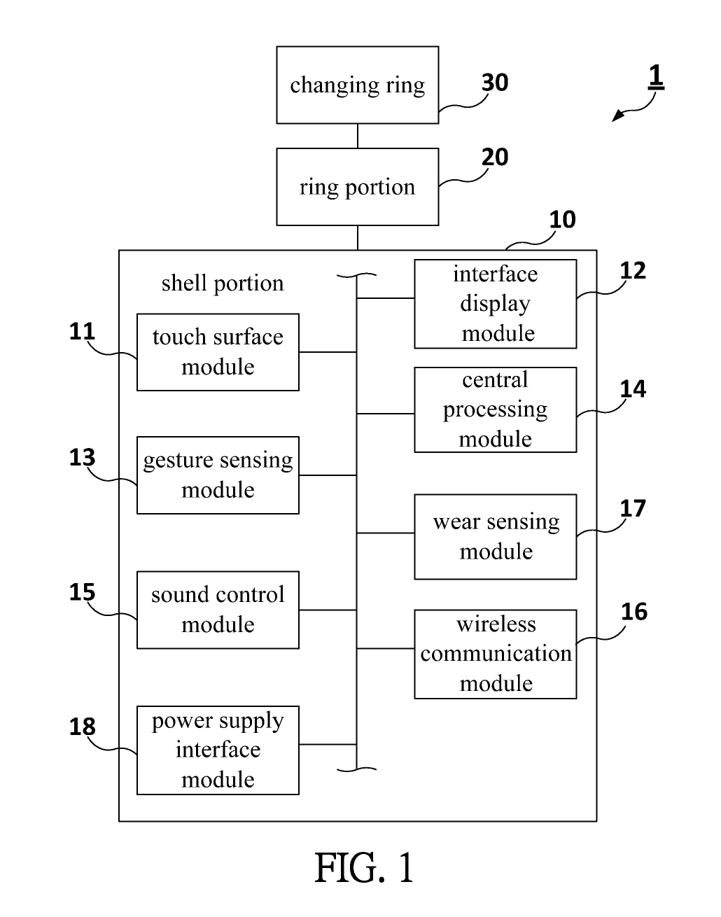

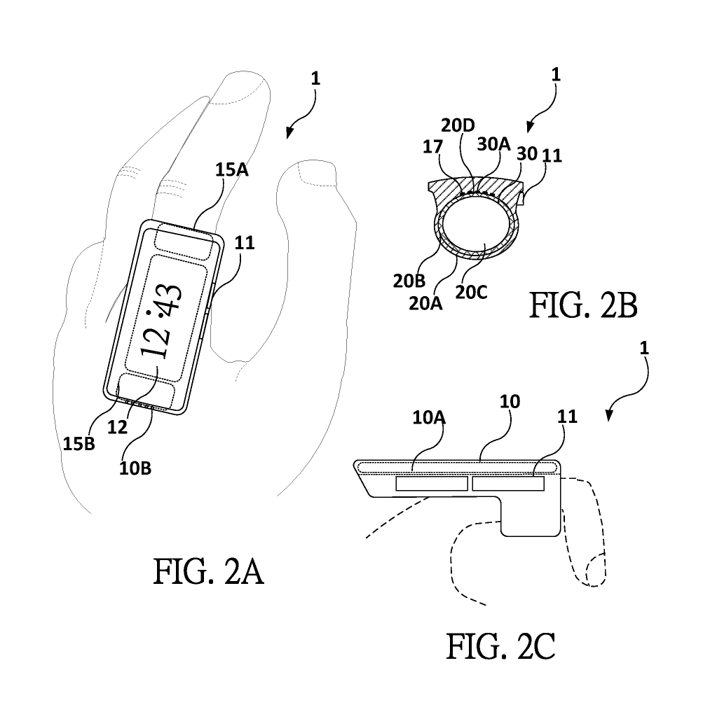

Please refer to FIG. 1 and FIG. 2A to FIG. 2C. FIG. 1 is a schematic diagram of the function block of the device in an embodiment of the invention, and FIG. 2A to FIG. 2C are schematic diagrams of the wearable electronic device of the present invention in use in an embodiment of the invention. As shown in FIG. 2A to FIG. 2C, the present invention comprises a changing ring 30, a ring portion 20, and a shell portion 10. The changing ring 30 and the shell portion 10 are set on the inner surface 20B and the outer surface 20A of the ring portion 20 individually.

The shell portion 10 further comprises a touch surface module 11, a interface display module 12, a gesture sensing module 13, a central processing module 14, a sound control module 15, a wireless communication module 16, a wear sensing module 17, and a power supply interface module 18.

Please refer to FIG. 2A to FIG. 2C. To further illustrate the features of the present invention, the scale of the elements in the figures has been adjusted, so the scale in each figure may be different. As shown in FIG. 2A to 2C, the wearable ring-shaped electronic device comprises a ring portion 20 and a shell portion 10, wherein the shell portion 10 is fixed on one end of the ring portion and has a holding place 10A. The ring portion 20 is formed a ring shaped and has an outer surface 20A and an inner surface 20B, wherein the middle is a hollow holding space 20C. The ring portion 20 is worn on the assigned finger of the user when in use. To adapt to the different sizes of fingers, a removable changeable ring 30 can be selectively set between the ring portion 20 and the finger of the user. The outer diameter of the changeable ring 30 is a little bigger than the inner diameter of the ring portion 20 or the same as the inner diameter of the ring portion 20, so the changeable ring 30 is able to be fixed into the ring portion 20. The inner diameter of the changeable ring 30 depends on the size of the finger of the user. Additionally, the outer surface of the changeable ring 30 has a prominent portion 30A, used to be fixed with the dent portion 20D of the inner surface of the ring portion 20. This makes possible that the ring portion 20 simply served as a ring base, leaving the task of enclosing the finger to the changeable ring portion 30. In this embodiment, the changeable ring 30 is made out of silicone to make it closely attach to the finger.

In this embodiment, the shell portion 10 of the present invention is set on the end which is away from the top end of the finger. When in use, the shell portion 10 does not have to be in contact with the finger or the back of the hand of the user. As shown in FIG. 2C, the shell portion 10 is suspended and distanced from the skin, so the scale of the display screen is not limited by the length of the finger.

As shown in the figure, the shell portion 10 of the present invention is set on one side of the ring portion 20 and comprises a touch surface module 11, an interface display module 12, a central processing module 14, a sound exporting element 15A and a sound receiving element 15B comprised in the sound control module 15, a wireless communication module 16, and a power supply interface module 18. In this embodiment, the power supply interface module 18 is a wireless charging coil. When the power supply interface module 18 is a wireless charging coil, the power supply interface module 18 is set inside the shell portion 10 and is not exposed outside. The present invention is not limited to the statement mentioned above. The power supply interface module 18 also can be a kinematic energy collector that utilizes the movement of the user to produce kinematic energy that can charge the battery (not shown in the figure) comprised in the power supply interface module 18. Another option for charging the battery is to use a MICRO-B USB cable connected from the power supply interface module 18 to a power source. According to this embodiment, when the wearable ring-shaped electronic device 1 is worn, the end of the connection port is set on top of the finger and faced towards the base of the finger. It is important to note that the power supply interface module 18 is not limited to the MICRO-B USB, kinematic energy collector, or wireless charging coil. The power supply interface module 18 can be replaced by any other types of connection port or wireless charging method.

In this embodiment, the wearable ring-shaped electronic device 1 is worn on the third knuckle of the forefinger of left hand, and the touch surface module 11 is facing towards the thumb of left hand for easy control. But the present invention is not limited to the specific knuckle or hand. In this embodiment, the touch surface module 11 comprises a plurality of independent electrical buttons where the present invention is not limited to the statements mentioned above. According to the preference of the user, the touch surface module 11 can be a real button or a touch screen for the user to enter different commands. If the touch surface module 11 is a touch screen, the touch portion of the touch screen is advised to face the thumb for convenience in control. It is important to note that the touch surface module 11 of the present invention is not limited by the two statements mentioned above. Generally, a module which can be used for the user to input a command to the central processing module 14 through their finger and generating a command to actuate the corresponding assigned function is comprised in the touch surface module 11 of the present invention. For example, aside from pressing a button, the touch surface module 11 can further comprise a rollable wheel form interface, etc., this present invention is not limited to what is described in this embodiment.

In this embodiment, the interface display module 12 is an electronic paper display device, but it is not limited to the statement mentioned above. As long as an element is fixed to the ring portion 20 and coupled to the central processing module 14 for displaying information according to the control of the central processing module 14, the element can be the interface display module 12 of the present invention. For example, the interface display module 12 can use LED, LCD, or any other display technology to present the information, the present invention is not limited to this embodiment. When the interface display module 12 is a touch screen, the interface display module 12 is integrated with the touch surface module 11 mentioned above. It is worth knowing that in this embodiment, the electronic paper can also extend or connect to one or more of the buttons to act as the touch surface module 11 mentioned above.

Additionally, the gesture sensing module 13 of the present invention is set in the holding place 10A and fixed on one side of the shell portion 10 to sense movement from the user. More particularly, a soft circuit board is set in the holding place 10A, with the gesture sensing module 13 coupled to the circuit board to receive the power and the signal. In this embodiment, the gesture sensing module 13 can be integrated by an accelerometer and a gyroscope to be a multi-axis and inclined-angle sensor. It can also further integrate a magnetic sensor to be a multi-axis and inclined-angle sensor. The multi-axis and inclined-angle sensor can detect the position or the orientation of the surface and sense every axial direction of the acceleration for inputting gestures. Using the gesture sensing module 13, the user's movement can be shown through a combination of velocity, acceleration, angle, etc. The present invention is not limited to the statements mentioned above. As long as the element is used to sense finger movement from the user, the element is comprised in gesture sensing module 13.

Furthermore, the gesture sensing module 13 and the sound control module 15 are also set in the holding place 10A with some areas of the elements exposed through a hole to release sound or receive voice input. The sound control module 15 is coupled to the circuit board and comprises a sound exporting element 15A and a sound receiving element 15B. The sound exporting element 15A could be a small speaker, while the sound receiving element 15B could be a small microphone, wherein the sound exporting element 15A and the sound receiving element 15B are each set on the two sides of the shell portion 10. The sound receiving element 15B faces towards the base of the finger, while the sound exporting element 15A faces towards the fingertips. With this arrangement, whenever the user lifts their hand near their face, the sound receiving element 15B is close to the mouth and the sound exporting element is closer to the ear, improving the quality of the released sound and the inputted voice. The sound control module of the present invention is not limited by this embodiment. As long as the sound control module releases sound to the user or receives sound input from the user to control an assigned function element of the central processing module, it is comprised in the sound control module 15.

According to an embodiment of this invention, the wireless communication module 16 is set in the holding place 10A and coupled to the circuit board. The wireless communication module 16 comprises a wireless communication chip and a communication antenna. In this embodiment, the wireless communication chip is a bluetooth chip, though the present invention is not limited to it. As long as a wireless communication chip is coupled to and controlled by the central processing module 14 for connecting or exchanging data with a remote device placed outside of the holding place 10A of the wearable ring-shaped electronic device 1, it is comprised in the wireless communication module 16. For example, even though the wireless communication module 16 of the present invention utilizes a bluetooth function, there are many other wireless communication options that can be used, such as 2G, 3G, WiFi, or infrared communication chips. The remote device mentioned above could be a wireless controlled television, router, cell phone, computer, game system or cell phone base station. The wireless communication module further comprises a proximity data exchange chip. The present invention could use the proximity chip to communicate with other nearby devices of the same type, wherein the communication could be used for exchanging business cards or simultaneously playing music. Furthermore, the user could use the safe exchange between the proximity chip of the present invention and that of the cell phone to replace the required security measures of passwords, codes, graphs or other bio-sensors of today's cell phones.

According to the same embodiment of this invention, the wear sensing module 17 has a pressure sensing plate, set on the inside of the ring portion 20. The resistance of the sensing plate will rise whenever pressure is applied to the sensing plate. The sensing plate allows the wearable ring-shaped electronic device 1 to recognize when it is being worn through the pressure signal of the sensing plate. However, the present invention is not limited to a sensing plate. The wearable ring-shaped electronic device could also use a light sensor or an actuator sensor to detect whether the user is wearing the device or not.

According to the same embodiment of this invention, the central processing module 14 is positioned in the holding place 10A of the shell portion 10 and coupled to the circuit board. In this embodiment, the central processing module 14 is a single chip system, but the present invention is not limited by it. As long as the element can generate a control command to actuate a corresponding assigned function according to the command exported by the gesture sensing module 13, sound control module 15, wireless communication module 16, wear sensing module 17, or touching surface module 11, then is comprised in the central processing module 14 of the present invention. For example, the central processing module 14 of the present invention could also be a CPU and a combination of its software and hardware.

Now that every element has been defined, the following will explain the methods of using the present invention. According to an embodiment of the invention, the central processing module 14 of the wearable ring-shaped electronic device 1 can control the sound control module 15 and the wireless communication module 16 to provide a voice communication function. The voice communication function allows the user to control the sound control module 15 and the wireless communication module 16 of the wearable ring-shaped electronic device 1 by sending voice package or communicating with other devices through a signal compilation device. The signal compilation device is a cell phone or base station which supports mobile communication protocols. The present invention is not limited by the voice package. Depending on the requirements of the user, the signal compilation device could also be an internet transmission element supporting bluetooth communication.

Furthermore, the present invention includes a voice control function. The voice control function uses the sound control module 15 of the wearable ring-shaped electronic device 1 and acquires the sound input of the user. The sound input is then transmitted to the central processing module 14 to generate a control command to actuate a corresponding function or to transmit the sound input to a remote device using the wireless communication module 16. After the remote device analyzes the sound input, it then generates a corresponding control command of the remote device. The voice control function could be activated with the gesture sensing module 13 or the touch surface module 11. For example, the user could press a button on the touch surface module 11 to activate the voice control function, and then use their voice to control the wearable ring-shaped electronic device 1 to perform functions such as dialing, recording, seeing the time or performing a search.

Additionally, the present invention includes a body control function. The body control function utilizes the gesture sensing module 13 of the wearable ring-shaped electronic device 1 to acquire movement from the user and transmit the movement to the central processing module 14 to generate a control command that performs a corresponding function. For example, when the user rotates their hand, the gesture sensing module 13 obtains each acceleration vector and transmits it to the central processing module 14 to be analyzed. In this embodiment, whenever the user lifts their hand towards their face, the voice control function will activate. The gesture sensing module 13 recognizes the movement of the hand through its acceleration and angle of movement and sends a command to the sound control module to activate the voice control function. The following steps for usage comprises: the gesture sensing module sensing an acceleration and an inclined angle of movement; using the acceleration and the inclined angle to identify whether the movement corresponds with a predetermined database of movement commands; if the movement does correspond with the predetermined database of movement commands, continue the following steps of; turning on the interface display module to display predetermined data, wherein the predetermined data comprises time, messages, notifications and updated information. In addition, the corresponding function mentioned above could also comprise a control function. The control function moves the cursor and inputs object-control commands on an associated display device according to movement from the user. For example, when the hand of the user moves to the left, the cursor also moves to the left, and similar controls can also be done by moving the hand up, down, and right. When the user moves their hand away from their body, the movement corresponds to a click function and moving their hand away quickly corresponds to a cancel function. Using combinations of direction or movement, the present invention proposes commands for selecting, enlarging, or shrinking what is being displayed.

The central processing module 14 of the present invention also comprises an automatic on/off function. The automatic on/off function switches the wearable ring-shaped electronic device 1 between an on mode and an off mode by sensing the pressure from the pressure sensing module. When in on mode, every element of the device works normally. When in off mode, many elements of the device are turned off to conserve energy. The wearable ring-shaped electronic device automatically determines whether it should be on or off through the wear sensing module. If the wearable ring-shaped electronic device is determined to be in use and on, it will automatically control the wireless communication module to wirelessly connect to the display device and transmit an exchange signal to the central processing module, wherein the exchange signal comprises data corresponding to movements or sound commands from the user to control the remote device. The remote device mentioned above can be a cell phone, iPad, television, notebook, tablet, or any device that has the function of displaying data. When the user wears the wearable ring-shaped electronic device 1, the device will switch on and vice versa. When the device is switched on, it will use the wireless communication module to wirelessly connect with the outside device to exchange data or perform control functions.

In addition to the on/off function, the central processing module 14 of the present invention also includes an energy conserving function. Gesture signals from the gesture sensing module 13 can switch the wearable ring-shaped electronic device 1 between a normal mode and a power conservation mode, wherein during the power conservation mode, some elements or modules of the wearable ring-shaped electronic device 1 are in a power conservation mode or an off mode, consuming less power than in the normal mode. The normal mode is a mode where each module of the present invention functions normally at the same time, but consumes more power. According to this embodiment, the mode changing function switches the device from the power conservation mode to the normal mode through the gesture signals from the gesture sensing module, and vice versa. In another embodiment of present invention, the mode changing function switches the device from the power conservation mode to the normal mode through a combined sequence of a gesture signal from the gesture sensing module 13 and a sound input signal from the sound control module 15. For example, the device only switches to normal mode after confirmation of both a predetermined gesture signal and a particular sound signal received at the central processing module 14 to avoid unintentional normal mode activation of the device. The present invention is not limited to this condition though, as there can be conditions such as switching modes when no predetermined movement detected as the time period reaches threshold value. For example, when the device senses that there has been no movement for thirty seconds, it will switch the mode to power conservation automatically.

According to the above embodiments, when the wireless communication module of the present invention comprises a proximity chip, then it can further enable secure information exchange function between proximity chips. The information exchange function allows the user to use the proximity chip to exchange data and ID information with the other nearby proximity chips. To be more precise, when exchanging information using the proximity chip, the steps comprise the following steps of: using the proximity chip to exchange data and ID information with a security terminal containing another proximity chip; using the wireless communication module to transmit an exchange signal to the remote device, in this embodiment, the remote device is a cell phone and the exchange signal is a trade verifying signal; transmitting back the verified exchange signal from the remote device through the wireless communication to the security terminal; and the trade verification is completed. The present invention also proposes a method of two-factor authentication to increase security when exchanging information between devices. The method is that aside from the ID information in the cell phone, the user has to provide a second means of identification for authentication verification, wherein the second means of identification is stored and verified in the device of the present invention. In a situation involving verifying information with a security terminal, the security terminal could exchange information using the proximity chip of the present invention and separately connect to and verify with the cell phone to achieve two-factor authentication instead of relaying information through the present invention to the cell phone and then back to the security terminal. According to this embodiment, both the present invention and the cell phone are carried by the user and physically at a close-vicinity with the security terminal. The physical presence of both the present invention and the cell phone removes the need for additional user operation required in a typical web-password plus SMS-key type two-factor authentication. In another situation, the security terminal could use the cell phone to acquire the second identity information existed on the present invention for the second authentication, thus completed two-factor authentication. In addition, the device of the present invention can use the proximity chip to perform data synchronization with another proximity chip. In other situations, the user can use the proximity chip of the present invention and the proximity field of the cell phone to replace codes, graphs or other distinguishing functions the cell phone employed as security measures.

To summarize, the present invention discloses a wearable ring shaped electronic device, more specifically, the present invention is a novel model of an electronic device with a ring shape that is capable of being worn on the finger of a user. Furthermore, the present invention is capable of being controlled by voice, motions, orientations, buttons or a touch panel set on the surface thereof so as to provide a corresponding function. In addition, because it is worn on one finger, other fingers of the same hand can control it. The user can also use one hand to control the wearable ring-shaped electronic device to perform an assigned function without diverting their attention by activating a command using acceleration vectors and inclined angles, their voice, pressing buttons or touching the touch panel.

If the specification mentions that A is electrically coupled or connected to B, it means that there is transmission of energy, data or signals between A and B, and is not limited to tangible connections. It does not matter if the method of transmission is wireless, so the transmission of electricity, light and magnetization are comprised in it. Moreover, the parts of the device, element and modules mentioned in the specification are not limited to independent real hardware; it could also be presented by individual or integrated software and firmware.

With the examples and explanations above, the features and spirits of the invention will be hopefully well described. Importantly, the present invention is not limited to the embodiment described herein. Those skilled in the art will readily observe that numerous modifications and alterations of the device may be made while retaining the teaching of the invention. Accordingly, the above disclosure should be construed as limited only by the metes and bounds of the appended claims.

1. A wearable ring-shaped electronic device, comprising:
a ring portion, having a ring shape that forms a holding space for a user's finger to wear;
a gesture sensing module, fixed to the ring portion to sense a movement from the user's finger;
a sound control module, fixed to the ring portion to receive a sound input from the user or play a sound to the user; and
a central processing module, fixed to the ring portion and coupled to the gesture sensing module and the sound control module to generate a control command and perform a corresponding assigned function according to the movement or the sound input of the user.

2. The wearable ring-shaped electronic device of claim 1, wherein the wearable ring-shaped electronic device further comprises a wireless communication module, fixed to the ring portion and coupled to the central processing module, controlled by the central processing module to exchange data with a remote device set outside of the wearable ring-shaped electronic device.

3. The wearable ring-shaped electronic device of claim 2, wherein the wireless communication module comprises a wireless communication chip, the remote device is a signal compilation device, and the assigned function is a voice communication function, the voice communication function allows the user to communicate with others through the signal compilation device by using the sound control module of the wearable ring-shaped electronic device.

4. The wearable ring-shape electronic device of claim 2, wherein the wireless communication module comprises a wireless communication chip, and the assigned function is a voice control function, the voice control function allows the user to input a voice command using the sound control module to generate a control command to a corresponding function by the central processing module, or by the remote device using the wireless communication module.

5. The wearable ring-shaped electronic device of claim 2, wherein the wireless communication module comprises a proximity chip, the assigned function is an information exchange function that allows the user to use the proximity chip of the wearable ring-shaped electronic device to exchange a set of data and ID information with a nearby device containing another proximity chip.

6. The wearable ring-shaped electronic device of claim 1, wherein the wearable ring-shaped electronic device further comprises a wear sensing module, connected to the ring portion and coupled to the central processing module to sense whether or not the user is wearing the wearable ring-shaped electronic device and to generate a wear signal, the central processing module can switch on or off the wearable ring-shaped electronic device according to the wear signal.

7. The wearable ring-shaped electronic device of claim 1, wherein the central processing module has a mode changing function, according to a predetermined gesture signal generated from the gesture sensing module, the mode changing function makes the central processing module switch the wearable ring-shaped electronic device to a normal mode or a power conservation mode, wherein the power conservation mode consumes less power than the normal mode.

8. The wearable ring-shaped electronic device of claim 1, wherein the wearable ring-shaped electronic device further comprises a touch surface module, fixed to the ring portion for inputting a touch signal from the user's finger and making the central processing module generate a control command to perform a corresponding assigned function based on the touch signal.

9. The wearable ring-shaped electronic device of claim 1, wherein the wearable ring-shaped electronic device further comprises an interface display module, fixed to the ring portion and coupled to the central processing module to display information to the user through the control of the central processing module.

10. The wearable ring-shaped electronic device of claim 1, wherein the central processing module has an open function for the sound control module to determine the opening or closing of the sound control module according to a predetermined gesture signal generated from the gesture sensing module.

11. A control method of a wearable ring-shaped electronic device, the wearable ring-shaped electronic device comprising a ring portion, having a ring shape and forming a holding space for a user's finger to wear; a gesture sensing module, fixed to the ring portion to sense a movement of the user's finger; a sound control module, fixed to the ring portion to receive a sound input from the user or play a sound to the user; a wireless communication module to exchange data with a remote device set outside of the wearable ring-shaped electronic device; and a central processing module, fixed to the ring portion and coupled to the gesture sensing module, the sound control module, and the wireless communication module to generate a control command and perform a corresponding assigned function according to the movement or the sound input of the user, and exchanging data with the remote device set outside of the wearable ring-shaped electronic device, the control method comprising the following steps of:
determining whether the wearable ring-shaped electronic device is in an on mode or off mode by an user activation command; and
controlling the wireless communication module for the wearable ring-shaped electronic device to be wirelessly coupled to the remote device and transmitting an exchange signal automatically if the wearable ring-shaped electronic device is in the on mode, wherein the exchange signal comprises data corresponding to the movement or the sound input of the user.

12. The control method of the wearable ring-shaped electronic device of claim 11, wherein the wearable ring-shaped electronic device further comprising a wear sensing module, connected to the ring portion and coupled to the central processing module; or a touch surface module, connected to the ring portion and coupled to the central processing module, and the user activation command corresponds to an automatic wear detection using the wear sensing module or to a user touch input using the touch surface module of the wearable ring-shaped electronic device.

13. The control method of the wearable ring-shaped electronic device of claim 11, wherein the movement corresponds to the motion of the wearable ring-shaped electronic device being lifted nearby or moved away from the face of the user.

14. The control method of the wearable ring-shaped electronic device of claim 11, further comprising the following steps of:
using the gesture sensing module to sense an acceleration and an inclined angle of the movement;
using the acceleration and the inclined angle to identify the movement of the user;
identifying whether the movement corresponds with a predetermined movement data for sound input or not; if the movement corresponds with the predetermined movement data for sound input, continuing the following step of; and
turning on the sound control module to receive the sound input.

15. The control method of the wearable ring-shaped electronic device of claim 14, further comprising the following steps of:
sending the sound input to the central processing module;
using the central processing module to identify whether the sound input corresponds with a predetermined voice command data or not;
if the sound input corresponds with the predetermined voice command data, receiving further a sound input, wherein the sound control module remains on; and
if the sound input does not correspond with the predetermined voice command data within a pre-specified time of threshold value, turning off the sound control module to conserve power.

16. The control method of the wearable ring-shaped electronic device of claim 11, wherein the wearable ring-shaped electronic device further comprises an interface display module, the control method further comprising the following steps of:
using the gesture sensing module to sense an acceleration and an inclined angle of the movement;
using the acceleration and the inclined angle to identify whether the movement corresponds with a predetermined display movement data or not; if the movement corresponds with the predetermined display movement data, continuing the following step of; and
turning on the interface display module to display a predetermined data, wherein the predetermined data comprises time, messages, notifications and updated information.

17. The control method of the wearable ring-shaped electronic device of claim 11 further comprising the following steps of:
using the gesture sensing module to sense an acceleration and an inclined angle of the movement;
using the acceleration and the inclined angle to identify the movement of the user;
identifying whether or not the movement corresponds with a predetermined movement data of the remote device control; if the movement corresponds with the predetermined movement data of the remote device control, the central processing module directs the remote device to execute a corresponding assigned function, wherein the assigned function is an indicating control function, and according to the movement, the indicating control function inputs an object-control command and performs remote control.

18. The control method of the wearable ring-shaped electronic device of claim 11, wherein the wireless communication module, wirelessly coupled to the remote device through the wireless communication module, further comprises a proximity chip to exchange data and ID information, when the proximity chip is in a distance which it can be wirelessly coupled to a nearby security terminal containing another proximity chip for a trade verification, the control method further comprising the following steps of:
using the proximity chip to exchange data and ID information with the nearby security terminal containing another proximity chip;
using the wireless communication module to transmit an exchange signal to the remote device, wherein the exchange signal is a trade verifying signal;
transmitting back the verified exchange signal from the remote device through wireless coupling to the security terminal; and
completing the trade verification.

19. The control method of the wearable ring-shaped electronic device of claim 11, wherein the wireless communication module, wirelessly coupled to the remote device at a close-vicinity, further comprises a proximity chip to exchange data and ID information, when the proximity chip is in a distance which it can be wirelessly coupled to a nearby security terminal containing another proximity chip for a trade verification, the control method further comprising the following steps of:
using the proximity chip to exchange a set of data and ID information with the nearby security terminal containing another proximity chip;
establishing a separate wireless connection between the security terminal and the remote device to exchange a second set of data and ID information;
verifying presence and information coming from the proximity chip of the wearable ring-shaped electronic device, and from the separate wireless connection with the remote device; and
completing the trade verification with two-factor authentication.

20. A control method of a wearable ring-shaped electronic device, a mobile device, and a security terminal physically at a close-vicinity, the wearable ring-shaped electronic device comprising a ring portion forming a holding space for a user's finger to wear, a proximity chip fixed to the ring portion for exchanging a set of data and ID information with a nearby security terminal containing another proximity chip, the mobile device comprising a wireless communication module for establishing wireless connection with the security terminal to exchange a second set of data and ID information stored in the mobile device and verify physical presence, the security terminal comprising a proximity chip and a wireless communication module to exchange data and ID information with the wearable ring-shaped electronic device and the mobile device respectively, wherein the proximity chip of the wearable ring-shaped electronic device is in a distance which it can be wirelessly coupled to the proximity chip of the security terminal for a trade verification, the control method comprising the following steps of:
using the proximity chip of the security terminal to exchange a set of data and ID information with the nearby proximity chip of the wearable ring-shaped electronic device;
establishing a separate wireless connection between the security terminal and the mobile device to exchange the second set of data and ID information;
verifying presence and information coming from the proximity chip of the wearable ring-shaped electronic device, and from the separate wireless connection with the mobile device; and
completing the trade verification with two-factor authentication.
